(19) United States
(12) Patent Application Publication
(10) Pub. No.: US 2026/0368764 A1
(43) Pub. Date: Nov. 19, 2026

(54) Connecting Searches With Digital Content

(71) Applicant: Google LLC, Mountain View, CA (US)

(72) Inventors: Charles Huyi, Ann Arbor, MI (US); Yonathan Schwarzkopf, Pasadena, CA (US); Jeffrey Wilhelm, Palos Verdes Estates, CA (US); Jay Lieske, JR., Los Angeles, CA (US); Jiaxin Shao, Santa Clara, CA (US); Jing Wang, Falls Church, VA (US); Claire Smith, San Rafael, CA (US); David Quintero, New York, NY (US); Jeffrey Yam, Torrance, CA (US); Jiro Root, Berkeley, CA (US); Jonathan Harel, Los Angeles, CA (US); Anton Nemchenko, Redondo Beach, CA (US); Tommy Truong, Los Angeles, CA (US); Stephanie Shin-hui Zhang, Chatham, NJ (US); Jonathan Sirlin, Tarrytown, NY (US); Kechy Eke, Los Angeles, CA (US); Alexander Howard, Chicago, IL (US); Dattatraya Koujalagi, Fremont, CA (US); Ankur Agiwal, San Jose, CA (US); Chaolun Zhang, San Jose, CA (US); John Chen, Mountain View, CA (US); Harikesh Sasikumar Nair, Palo Alto, CA (US)

(21) Appl. No.: 19/207,940

(22) Filed: May 14, 2025

(51) Int. Cl. G06Q 30/0202

(52) U.S. Cl. CPC G06Q 30/0202

(57) ABSTRACT

Aspects of the disclosure are directed to attributing searches conducted by users with digital content previously viewed by those users. The attribution can involve determining whether a user conducts a search for a brand, product, and/or service within a predetermined period of time after viewing digital content associated with the brand, product, and/or service. Rather than setting up tracking of digital content campaigns or limiting the tracking to predetermined keywords, the attribution uses a machine learning model to identify any brands, products, and/or services associated with digital content and to map the searches of a user to the identified brands, products, and/or services after the user views the digital content. This allows for more accurate measures of effectiveness of digital content campaigns with reduced processing costs and memory usage.

### BACKGROUND

Digital content providers want to measure how effectively their digital content generates demand among users. One way to measure effectiveness is through searches related to the digital content after viewing the digital content. Typically, a digital content provider sets up a trial program that runs over a predetermined duration, e.g., 30 days. The program compares searches matching predefined keywords to the digital content between users who may or may not have viewed the digital content. However, this program is limited to the predefined duration and keywords. This reduces the sensitivity and coverage of the program, particularly if users conducted searches related to the digital content that were outside of the predetermined duration and/or that did not include any of the predefined keywords. Further, this program needs to be set up and included as part of any digital content campaign, which can increase processing costs and memory usage to have the program run while serving the digital content.

### BRIEF SUMMARY

Aspects of the disclosure are directed to attributing searches conducted by users with digital content previously viewed by those users. The attribution can involve determining whether a user conducts a search for a brand, product, and/or service within a predetermined period of time after viewing digital content associated with the brand, product, and/or service. The attribution uses a machine learning model to identify any brands, products, and/or services associated with digital content and to map the searches of a user to the identified brands, products, and/or services after the user views the digital content. This allows for more accurate measures of effectiveness of digital content campaigns with reduced processing costs and memory usage.

An aspect of the disclosure provides for a method for attributing searches with digital content including: receiving, by the one or more processors, a search performed on a user device; identifying, by the one or more processors, at least one of a brand, product, or service from the search; mapping, by the one or more processors, the identified brand, product, or service to at least one of a brand, product, or service identified in digital content; determining, by the one or more processors, that the search was performed within a threshold time range from the digital content being viewed based on the mapping; and attributing, by the one or more processors, the search to the digital content based on the search being performed within the threshold time range from the digital content being viewed.

Another aspect of the disclosure provides for a system including: one or more processors; and one or more storage devices coupled to the one or more processors and storing instructions that, when executed by the one or more processors, cause the one or more processors to perform the method for attributing searches with digital content. Yet another aspect of the disclosure provides for a non-transitory computer readable medium for storing instructions that, when executed by one or more processors, cause the one or more processors to perform the method for attributing searches with digital content.

In some examples, the method further includes: receiving, by the one or more processors, the digital content viewed on the user device; and identifying, by the one or more processors, the brand, product, or service identified in the digital content.

In some examples, the search includes at least one of a text search, image search, video search, application search, artificial intelligence interface, or artificial intelligence agent.

In some examples, identifying the brand, product, or service from the search includes using a machine learning model to perform at least one of natural language processing or image or video analysis. In some examples, identifying the brand, product, or service includes extracting search terms from the search. In some examples, extracting the search terms includes using a machine learning model to perform natural language processing.

In some examples, mapping the identified brand, product, or service from the search to the brand, product, or service identified in the digital content is based on a knowledge graph. In some examples, the knowledge graph indicates a similarity of brands, products, or services identified in the search and the digital content.

In some examples, identifying the brand, product, or service from the search further includes storing the identified brand, product, or service with a timestamp indicating when the search was performed on the user device. In some examples, the method further includes storing the brand, product, or service identified in the digital content with a timestamp indicating when the digital content was viewed on the user device. In some examples, determining that the search was performed within the threshold time range further includes comparing a timestamp indicating when the digital content was viewed with a timestamp indicating when the search was performed. In some examples, determining that the search was performed within the threshold time range further includes determining that the timestamp indicating when the digital content was viewed was within the threshold time range from the timestamp indicating when the search was performed.

In some examples, the method further includes maintaining, by the one or more processors, a count of attributions for the search to the digital content. In some examples, the method further includes generating, by the one or more processors, a histogram including the count of attributions. In some examples, the method further includes identifying, by the one or more processors, categories of the brand, product, or service from the digital content. In some examples, the method further includes determining, by the one or more processors, a mind share count based on the count of attributions and the categories of the brand, product, or service. In some examples, determining the mind share count further includes determining a fraction of the count of attributions out of a total number of searches for the category of the brand, product, or service.

### BRIEF DESCRIPTION OF THE DRAWINGS

FIG. 1 depicts a block diagram of example search to digital content attribution according to aspects of the disclosure.

FIG. 2 depicts a block diagram of an example search attribution system according to aspects of the disclosure.

FIG. 3 depicts a block diagram of an example environment for implementing a search attribution system according to aspects of the disclosure.

FIG. 4 depicts a block diagram of example machine learning model architectures according to aspects of the disclosure.

FIG. 5 depicts a flow diagram of an example process for attributing searches conducted by users with digital content previously viewed by those users according to aspects of the disclosure.

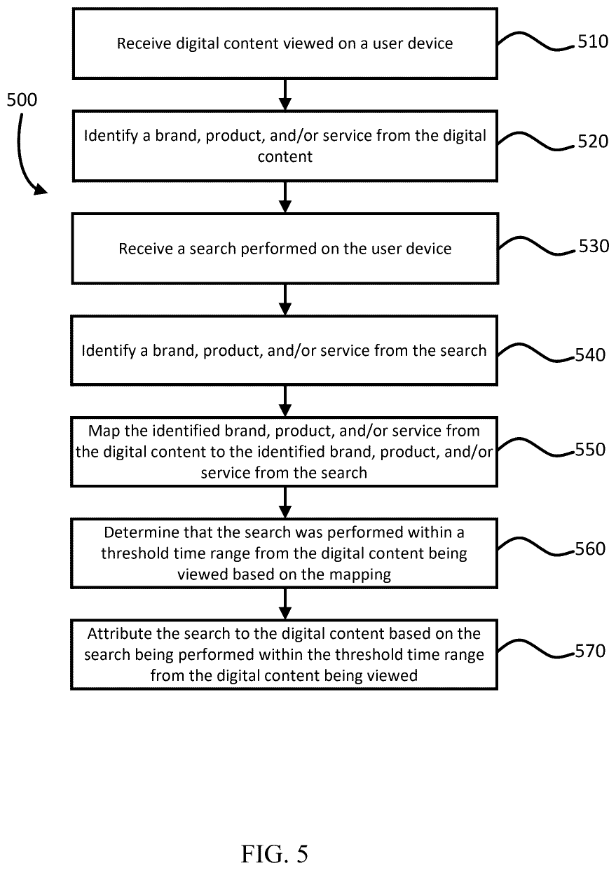

### DETAILED DESCRIPTION

The technology relates generally to an approach for connecting searches conducted by users with digital content previously viewed by those users. The approach can determine whether a user, after seeing particular digital content, subsequently conducts a search related to the digital content within a set period of time, e.g., within a day, week, etc. The approach does not require setting up a program with each digital content campaign, nor is the approach limited to predetermined keywords associated with the digital content for determining whether a related search was conducted. This allows for ongoing measures of effectiveness of digital content campaigns with reduced processing costs and memory usage.

The approach may measure an amount of distinct search queries issued by users who have viewed the particular digital content. The measurement can be performed within a particular attribution window, e.g., 28 days, or over a moving window, e.g., every 7 days. The distinct search queries can be measured from various search platforms, such as text search platforms, image search platforms, video search platforms, and/or application search platforms. The distinct search queries can also be measured from other platforms where users may express consideration for a digital content provider, such as artificial intelligence interfaces and/or agents. The approach attributes the measured search queries to digital content previously seen on the search and/or other platforms. The approach may classify the searches by intent and/or type of search, such as whether a search is related to a brand, product, service, etc.

The approach can also measure an impact of the digital content on mind share. Mind share refers to an empirical measurement that the popularity of a brand, product, service, etc., has within particular brand, product, or service categories. For example, a cola brand may intend to increase the popularity of the cola brand, such that any mention of cola beverages is referred to by the cola brand, regardless of whether the cola beverage is associated with that cola brand or not. The approach can measure the impact of the digital content on mind share by calculating a fraction of the brand, product, or service related searches a user has made after seeing the digital content out of their total number of searches for competitors or general categories of the brand, product, or service.

For a digital content campaign, the approach identifies any brands, products, and/or services that are part of the digital content and a category of the brands, products, and/or services. The approach can identify the brands, products, and/or services and categories using a machine learning model that analyzes aspects of the digital content campaign, such as digital content creatives, digital content landing pages, and/or metadata associated with the digital content. For each user that viewed the digital content, the approach classifies the relevant searches the user has made after viewing the digital content based on the identified brands, products, and/or services and categories. For example, the approach can classify the relevant searches by brand, product, competitor, and/or category. As another example, the approach can also classify the relevant search by intent of the user, such as whether the search is a comparison or price check. The approach can classify the relevant searches by extracting search terms and mapping the search terms to the brand, product, type of product, service, and/or categories of products, and/or services. The approach attributes the searches to a digital content impression if the search falls within a relevant time window from when the digital content was viewed. Since a given search may contain multiple brands, the approach may include a unique query identifier to deduplicate searches for providing attribution.

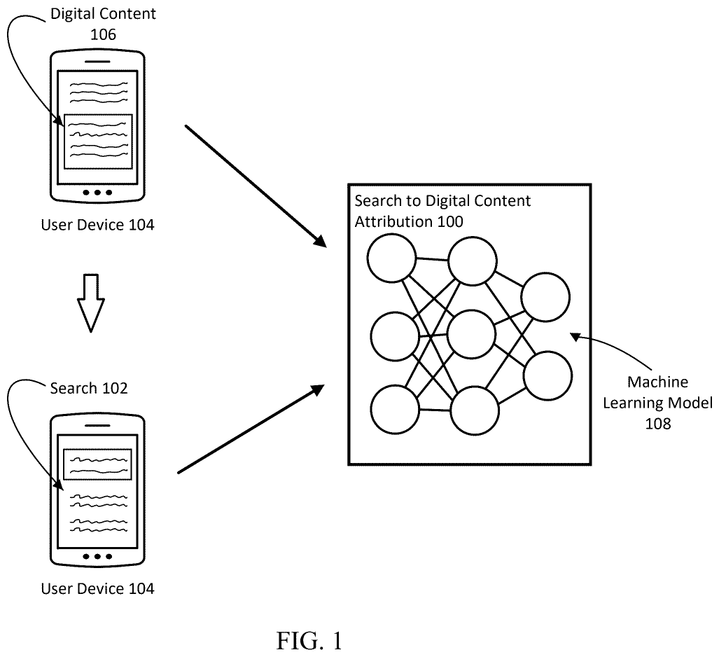

FIG. 1 depicts a block diagram of an example search to digital content attribution 100 for attributing searches 102 conducted by users on a user device 104 with digital content 106 previously viewed by those users on the same user device 104 or a different user device. The searches 102 may be part of any search platform, such as text, image, video, and/or application search platform, or other platform that involves queries, such as artificial intelligent interfaces or agents. The digital content 106 may be informative information, entertainment, advertisements, etc. The digital content may be a text, audio, image, and/or video. The user device 104 can be any computing device, such as a desktop computer, laptop computer, tablet, and/or smartphone.

The digital content attribution 100 can include a machine learning model 108. The machine learning model 108 can be an AI model, such as a large language model or a foundation model. The machine learning model 108 can be trained and/or fine-tuned to the task of identifying brands, products, and/or services, and categories of the brands, products, and/or services in the digital content 106. The machine learning model 108 can further be trained and/or fine-tuned to the task of identifying brands, products, and/or services from the searches 102 and mapping the identified brands, products, and/or services in the digital content 106 with the identified brands, products, and/or services in the searches 102. As part of identifying the brands, products, and/or services from the searches 102, the machine learning model 108 can be trained and/or fine-tuned to the tasks of extracting search terms from the searches 102, to reduce processing cost and memory usage in analyzing the searches 102. Searches 102 that are mapped to digital content 106 within a time window from when the user viewed the digital content 106 are attributed to the digital content 106.

The machine learning model 108 may include two models, with one model for identifying the brands, products, and/or services in the digital content 106 and the other model for identifying and mapping the brands, products, and/or services in the searches 102. Both models may be large language models, as an example. Alternatively, the machine learning model 108 may be a multi-modal model, such as a foundation model, where one part of the model identifies the brands, products, and/or services in the digital content 106 and/or the searches 102 and another part of the model maps the identified brands, products, and/or services.

The machine learning model 108 may receive the digital content 106 presented on the user device 104, indicating that a user viewed the digital content 106. The machine learning model 108 may process the digital content 106 to identify the brands, products, and/or services in the digital content 106. The machine learning model 108 may identify the brands, products, and/or services through natural language processing and/or image or video analysis. The machine learning model 108 may output the identified brands, products, and/or services. The identified brands, products, and/or services may be stored in a database for mapping to a search at a later point in time. The identified brands and/or product may be stored with a timestamp to indicate when the digital content 106 was viewed.

After the digital content 106 is presented on the user device 104, the machine learning model 108 may receive searches 102 performed on the user device 104. The machine learning model 108 may process the searches 102 to identify the brands, products, and/or services in the searches 102. The machine learning model 108 may identify the brands, products, and/or services through natural language processing and/or image or video analysis. The machine learning model 108 may output the identified brands, products, and/or services. The identified brands, products, and/or services may be stored in a database for mapping to digital content. The identified brands and/or product may be stored with a timestamp to indicate when the search was performed. Alternatively, or additionally, the machine learning model 108 may process the searches 102 to extract search terms for identifying the brands, products, and/or services. The machine learning model 108 may receive the identified brands, products, and/or services from the digital content 106 and the searches 102 and map the identified brands, products, and/or services to connect the searches 102 to the digital content 106. The machine learning model 108 may map the identified brands, products, and/or services using a knowledge graph indicating a similarity of identified brands, products, and/or services from the searches 102 and the digital content 106.

The machine learning model 108 may compare the timestamp of the identified brands, products, and/or services from the digital content 106 to the timestamp of the identified brands, products, and/or services from the searches 102. The machine learning model 108 may attribute searches 102 to digital content 106 when the timestamps are within a threshold time range.

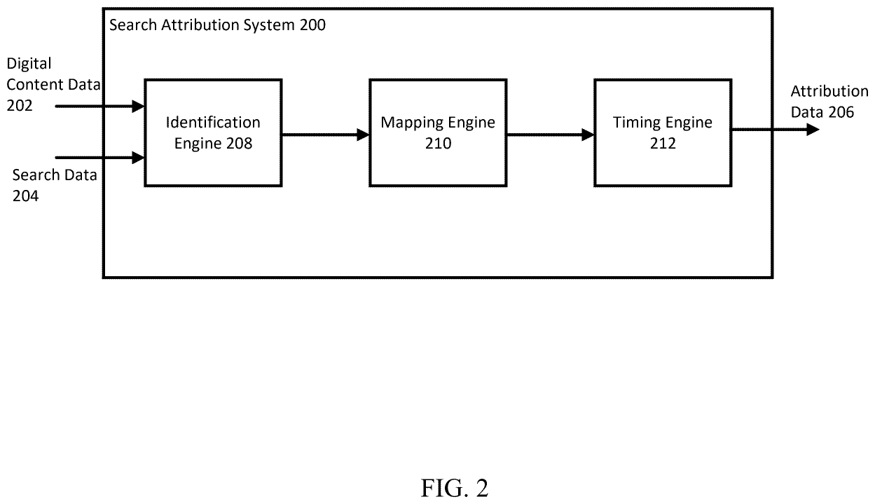

FIG. 2 depicts a block diagram of an example search attribution system 200. The search attribution system 200 can be implemented on one or more computing devices in one or more locations. The search attribution system 200 can correspond to the digital content attribution 100 as depicted in FIG. 1.

The search attribution system 200 can be configured to receive input data, including digital content data 202 and search data 204. The digital content data 202 can include data associated with a user viewing digital content, including the digital content itself as well as any metadata, such as a timestamp for when the user viewed the digital content. The search data 204 can include data associated with a user performing a search, including the content of the search as well as any metadata, such as a timestamp for when the user conducted the search. As an example, the search attribution system 200 200 can receive the input data as part of a call to an application programming interface (API) exposing the search attribution system 200 to one or more computing devices. The search attribution system 200 can also receive the input data through a storage medium, such as remote storage connected to one or more computing devices over a network. The search attribution system 200 can further receive the input data through a user interface on a user device.

Based on the input data, the search attribution system 200 can generate output data, including attribution data 206. The attribution data 206 can include data attributing particular searches to particular digital content. For example, the search attribution system 200 can be configured to send the attribution data 206 for display on a client or user display. The search attribution system 200 can also be configured to provide the attribution data 206 as a set of computer-readable instructions, such as one or more computer programs for attributing searches to digital content.

The computer programs can be written in any type of programming language, and according to any programming paradigm, e.g., declarative, procedural, assembly, object-oriented, data-oriented, functional, or imperative. The computer programs can be written to perform one or more different functions and to operate within a computing environment, e.g., on a physical device, virtual machine, or across multiple devices. The computer programs can also implement functionality described herein, for example, as performed by a system, engine, module, or model.

The search attribution system 200 can further be configured to forward the attribution data 206 to one or more other devices configured for translating the attribution data 206 for display or into an executable program written in a computer programming language for attributing searches to digital content. The search attribution system 200 can also be configured to send the attribution data 206 to a storage device for storage and later retrieval.

The search attribution system 200 can include an identification engine 208, a mapping engine 210, and a timing engine 212. The identification engine 208, mapping engine 210, and timing engine 212 can be implemented as one or more computer programs, specially configured electronic circuitry, or any combination thereof.

The identification engine 208 can be configured to identify brands, products, and/or services from digital content data 202. The identification engine 208 can also be configured to identify categories of the brands, products, and/or services from the digital content data 202. The identification engine 208 can implement a machine learning model to process the digital content data 202 through natural language processing and/or image or video analysis, depending on the type of the digital content, to identify the brands, products, and/or services and/or categories. The identification engine 208 can use the machine learning model to process aspects of the digital content data 202, including digital content creatives, digital content landing pages, and/or metadata associated with the digital content, e.g., uniform resource locators (URLs), creative names, and/or channels for the digital content. The identification engine 208 can store the identified brands, products, and/or services and/or categories in a database with a timestamp indicating when the digital content was viewed on a user device.

The identification engine 208 can be configured to identify brands, products, and/or services from the search data 204. The identification engine 208 can implement a machine learning model to process the search data 204 through natural language processing and/or image or video analysis, depending on the type of the digital content, to identify the brands, products, and/or services. As part of processing the search data 204, the identification engine 208 can also extract search terms from the search data 204 to reduce latency in identifying the brands, products, and/or services from the search data 204. The identification engine 208 can store the identified brands, products, and/or services and/or categories in a database with a timestamp indicating when the search was performed on a user device. The database may be the same database that stores the identified brands, products, and/or services from the digital content data 202 or a different database.

The mapping engine 210 can be configured to map the identified brands, products, and/or services from the digital content data 202 with the identified brands, products, and/or services from the search data 204. The mapping engine 210 can implement a machine learning model to map particular search terms to particular brands, products, and/or services. The machine learning model can use a knowledge graph that indicates a similarity of particular brands, products, and/or services from the digital content data 202 and the search data 204. The knowledge graph can include particular brands, products, and/or services as nodes and relationships between the particular brands, products, and/or services as edges. The knowledge graph can also include, as part of the nodes, whether the brands, products, and/or services were identified from digital content or from a search, and, as part of the edges, connecting brands, products, and/or services identified from digital content to brands, products, and/or service identified from search.

The timing engine 212 can be configured to determine whether to attribute a search to digital content based on the mapping. For mapped brands, products, and/or services, the timing engine 212 can compare the timestamp for when the digital content containing the identified brands, products, and/or services was viewed with the timestamp for when the search was performed. The timing engine 212 can attribute searches to digital content when the timestamps are within a threshold time range. The threshold time range can be a configurable threshold, such as one or more days, weeks, and/or months. For example, the threshold time range can be 28 days, such that the timing engine 212 can attribute a search to digital content if the timestamps for the search and digital content are within 28 days of each other.

The timing engine 212 can further be configured to maintain a count of attributions per digital content in response to determining to attribute a search to digital content. The timing engine 212 can output the attributions as a histogram or other graphical measurement of the attribution data 212. The timing engine 212 can also be configured to determine a mind share count based on the attributions per digital content by calculating a fraction the count of attributions per digital content out of a total number of searches for competitors or general categories of brands, products, and/or services of the digital content.

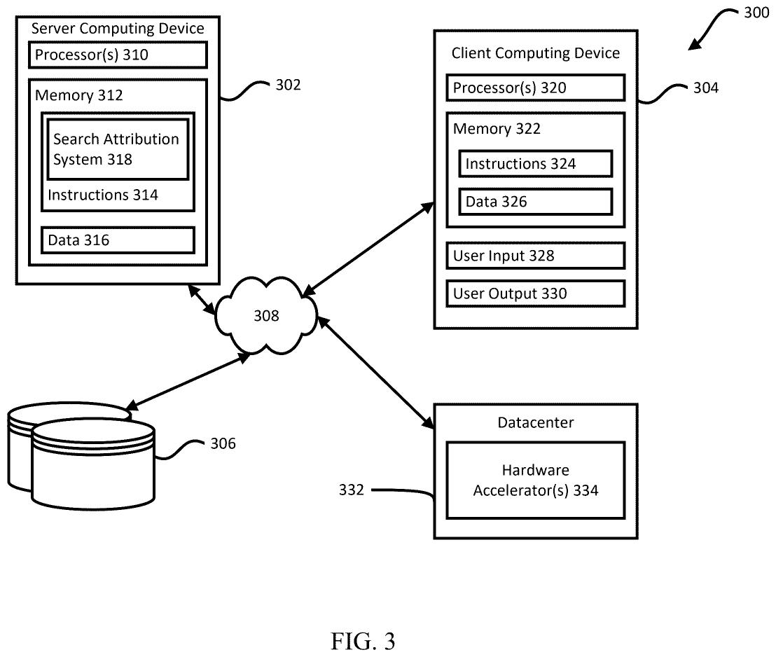

FIG. 3 depicts a block diagram of an example environment 300 for implementing a search attribution system 318. The search attribution system 318 can be implemented on one or more devices having one or more processors in one or more locations, such as in server computing device 302. A client computing device 304 and the server computing device 302 can be communicatively coupled to one or more storage devices 306 over a network 308. The storage devices 306 can be a combination of volatile and non-volatile memory and can be at the same or different physical locations than the computing devices 302, 304. For example, the storage devices 306 can include any type of non-transitory computer readable medium capable of storing information, such as a hard-drive, solid state drive, tape drive, optical storage, memory card, ROM, RAM, DVD, CD-ROM, write-capable, and read-only memories.

The server computing device 302 can include one or more processors 310 and memory 312. The memory 312 can store information accessible by the processors 310, including instructions 314 that can be executed by the processors 310. The memory 312 can also include data 316 that can be retrieved, manipulated, or stored by the processors 310. The memory 312 can be a type of transitory or non-transitory computer readable medium capable of storing information accessible by the processors 310, such as volatile and non-volatile memory. The processors 310 can include one or more central processing units (CPUs), graphic processing units (GPUs), field-programmable gate arrays (FPGAs), and/or application-specific integrated circuits (ASICs), such as tensor processing units (TPUs).

The instructions 314 can include one or more instructions that, when executed by the processors 310, cause the one or more processors 310 to perform actions defined by the instructions 314. The instructions 314 can be stored in object code format for direct processing by the processors 310, or in other formats including interpretable scripts or collections of independent source code modules that are interpreted on demand or compiled in advance. The instructions 314 can include instructions for implementing the search attribution system 318, which can correspond to the search attribution system 200 as depicted in FIG. 2. The search attribution system 318 can be executed using the processors 310, and/or using other processors remotely located from the server computing device 302.

The data 316 can be retrieved, stored, or modified by the processors 310 in accordance with the instructions 314. The data 316 can be stored in computer registers, in a relational or non-relational database as a table having a plurality of different fields and records, or as JSON, YAML, proto, or XML documents. The data 316 can also be formatted in a computer-readable format such as, but not limited to, binary values, ASCII, or Unicode. Moreover, the data 316 can include information sufficient to identify relevant information, such as numbers, descriptive text, proprietary codes, pointers, references to data stored in other memories, including other network locations, or information that is used by a function to calculate relevant data.

The client computing device 304 can also be configured similarly to the server computing device 302, with one or more processors 320, memory 322, instructions 324, and data 326. The client computing device 304 can also include a user input 328 and a user output 330. The user input 328 can include any appropriate mechanism or technique for receiving input from a user, such as keyboard, mouse, mechanical actuators, soft actuators, touchscreens, microphones, and sensors.

The server computing device 302 can be configured to transmit data to the client computing device 304, and the client computing device 304 can be configured to display at least a portion of the received data on a display implemented as part of the user output 330. The user output 330 can also be used for displaying an interface between the client computing device 304 and the server computing device 302. The user output 330 can alternatively or additionally include one or more speakers, transducers or other audio outputs, a haptic interface or other tactile feedback that provides non-visual and non-audible information to the platform user of the client computing device 304.

Although FIG. 3 illustrates the processors 310, 320 and the memories 312, 322 as being within the respective computing devices 302, 304, components described herein can include multiple processors and memories that can operate in different physical locations and not within the same computing device. For example, some of the instructions 314, 324 and the data 316, 326 can be stored on a removable SD card and others within a read-only computer chip. Some or all of the instructions 314, 324 and data 316, 326 can be stored in a location physically remote from, yet still accessible by, the processors 310, 320. Similarly, the processors 310, 320 can include a collection of processors that can perform concurrent and/or sequential operations. The computing devices 302, 304 can each include one or more internal clocks providing timing information, which can be used for time measurement for operations and programs run by the computing devices 302, 304.

The server computing device 302 can be connected over the network 308 to a data center 332 housing any number of hardware accelerators 334. The data center 332 can be one of multiple data centers or other facilities in which various types of computing devices, such as hardware accelerators, are located. Computing resources housed in the data center 332 can be specified for deploying models, such as for attributed searches to digital content, as described herein.

The server computing device 302 can be configured to receive requests to process data from the client computing device 304 on computing resources in the data center 332. For example, the environment 300 can be part of a computing platform configured to provide a variety of services to users, through various user interfaces and/or application programming interfaces (APIs) exposing the platform services. The client computing device 304 can transmit input data as part of a query. The digital content placement system 318 can receive intermediate data derived from the input data, and in response, generate output data including digital content placed with a response to the query.

The server computing device 302 can maintain a variety of models in accordance with different constraints available at the data center 332. For example, the server computing device 302 can maintain different families for deploying models on various types of TPUs and/or GPUs housed in the data center 332 or otherwise available for processing.

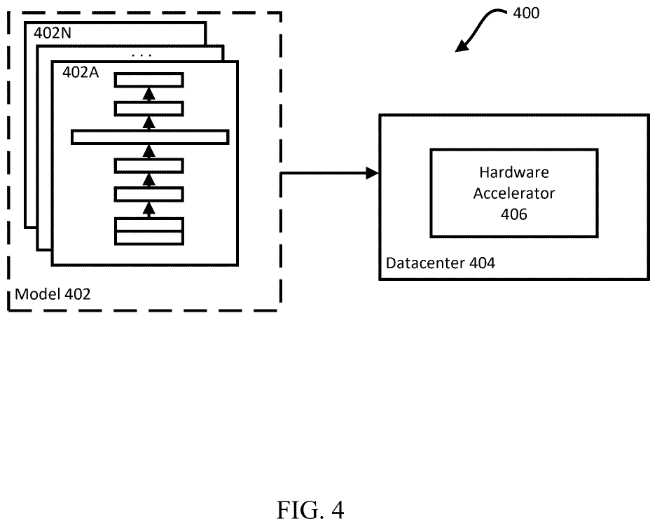

FIG. 4 depicts a block diagram 400 illustrating one or more machine learning model architectures 402 according to aspects of the disclosure. More specifically, FIG. 4 depicts architectures 402A-N for deployment in a datacenter 404 housing a hardware accelerator 406 on which the deployed machine learning models 402 execute, such as for the variety of services as described herein. The hardware accelerator 406 can be any type of processor, such as a CPU, GPU, FPGA, or ASIC such as a TPU.

An architecture 402 of a machine learning model can refer to characteristics defining the model, such as characteristics of layers for the model, how the layers process input, or how the layers interact with one another. The architecture 402 can also define types of operations performed within each layer. One or more machine learning model architectures 402 can be generated that can attribute searches to digital content. Example model architectures 402 can correspond to large language models and/or large foundation models.

The machine learning models can be trained according to a variety of different learning techniques. Learning techniques for training the machine learning models can include supervised learning, unsupervised learning, semi-supervised learning, and reinforcement learning techniques. For example, training data can include multiple training examples that can be received as input by a model. The training examples can be labeled with a desired output for the model when processing the labeled training examples. The label and the model output can be evaluated through a loss function to determine an error, which can be back propagated through the model to update weights for the model. For example, a supervised learning technique can be applied to calculate an error between outputs, with a ground-truth label of a training example processed by the model. Any of a variety of loss or error functions appropriate for the type of the task the model is being trained for can be utilized, such as cross-entropy loss for classification tasks, or mean square error for regression tasks. The gradient of the error with respect to the different weights of the candidate model on candidate hardware can be calculated, for example using a backpropagation algorithm, and the weights for the model can be updated. The model can be trained until stopping criteria are met, such as a number of iterations for training, a maximum period of time, a convergence, or when a minimum accuracy threshold is met.

Referring back to FIG. 3, the devices 302, 304 and the data center 332 can be capable of direct and indirect communication over the network 308. For example, using a network socket, the client computing device 304 can connect to a service operating in the data center 332 through an Internet protocol. The devices 302, 304 can set up listening sockets that may accept an initiating connection for sending and receiving information. The network 308 can include various configurations and protocols including the Internet, World Wide Web, intranets, virtual private networks, wide area networks, local networks, and private networks using communication protocols proprietary to one or more companies. The network 308 can support a variety of short-and long-range connections. The short-and long-range connections may be made over different bandwidths, such as 2.402 GHz to 2.480 GHz, commonly associated with the Bluetooth® standard, 2.4 GHz and 5 GHz, commonly associated with the Wi-Fi® communication protocol; or with a variety of communication standards, such as the LTE® standard for wireless broadband communication. The network 308, in addition or alternatively, can also support wired connections between the devices 302, 304 and the data center 332, including over various types of Ethernet connection.

Although a single server computing device 302, client computing device 304, storage device 306, and data center 332 are shown in FIG. 6, it is understood that aspects of the disclosure can be implemented according to a variety of different configurations and quantities of computing devices, including in paradigms for sequential or parallel processing, or over a distributed network of multiple devices. In some implementations, aspects of the disclosure can be performed on a single device connected to hardware accelerators configured for processing machine learning models, or any combination thereof.

FIG. depicts a flow diagram of an example process 500 for attributing searches with digital content. The example process 500 can be performed on a system of one or more processors in one or more locations, such as the search attribution system 200 as depicted in FIG. 2.

As shown in block 510, the search attribution system 200 receives digital content viewed on a user device. The digital content may be informative information, entertainment, advertisements, etc.

As shown in block 520, the search attribution system 200 identifies a brand, product, types of products or services, and/or categories of products or services from the digital content. The search attribution system 200 can identify the brand, product, and/or service using a machine learning model to perform at least one of natural language processing or image or video analysis. The machine learning model can process digital content creatives, digital content landing pages, and/or digital content metadata to identify the brand, product, or service. The search attribution system 200 can store the brand, product, and/or service with a timestamp indicating when the digital content was viewed on the user device.

As shown in block 530, the search attribution system 200 receives a search performed on the user device. The user device may be the same user device where the digital content was viewed or a different user device. The search may be a text search, image search, video search, application search, artificial intelligence interface, and/or artificial intelligence agent.

As shown in block 540, the search attribution system 200 identifies a brand, product, and/or service from the search. The search attribution system 200 can use a machine learning model to perform at least one of natural language processing or image or video analysis. The search attribution system 200 can also extract search terms from the search, such as by using a machine learning model to perform natural language processing. The search attribution system 200 can store the brand, product, and/or service with a timestamp indicating when the search was performed on the user device.

As shown in block 550, the search attribution system 200 maps the identified brand, product, and/or service from the search to the identified brand, product, and/or service from the digital content. The mapping can be based on a knowledge graph.. The knowledge graph can indicate a similarity of the brands, products, and/or services to the search terms.

As shown in block 560, the search attribution system 200 determines that the search was performed within a threshold time range from the digital content being viewed based on the mapping. The search attribution system 200 can compare the timestamp indicating when the digital content was viewed with the timestamp indicating when the search was performed.

As shown in block 570, the search attribution system 200 attributes the search to the digital content based on the search being performed within the threshold time range from the digital content being viewed. The search attribution system 200 can determine that the timestamp indicating when the digital content was viewed was within the threshold time range from the timestamp indicating when the search was performed.

The search attribution system 200 can maintain a count of attributions for the search to the digital content. The search attribution system 200 can generate a histogram containing the count of attributions.

The search attribution system 200 can identify categories of the brand, product, and/or service from the digital content. The search attribution system 200 can determine a mind share count based on the count of attributions and the categories of the brand, product, and/or service. The search attribution system 200 can determine a fraction of the count of attributions out of a total number of search for the category of the brand, product, and/or service.

Aspects of this disclosure can be implemented in digital electronic circuitry, in tangibly embodied computer software or firmware, and/or in computer hardware, such as the structure disclosed herein, their structural equivalents, or combinations thereof. Aspects of this disclosure can further be implemented as one or more computer programs, such as one or more modules of computer program instructions encoded on a tangible non-transitory computer storage medium for execution by, or to control the operation of, one or more data processing apparatus. The computer storage medium can be a machine-readable storage device, a machine-readable storage substrate, a random or serial access memory device, or combinations thereof. The computer program instructions can be encoded on an artificially generated propagated signal, such as a machine-generated electrical, optical, or electromagnetic signal, which is generated to encode information for transmission to suitable receiver apparatus for execution by a data processing apparatus.

The term “configured” is used herein in connection with systems and computer program components. For a system of one or more computers to be configured to perform particular operations or actions means that the system has installed thereon software, firmware, hardware, or a combination thereof that cause the system to perform the operations or actions. For one or more computer programs to be configured to perform particular operations or actions means that the one or more programs include instructions that, when executed by one or more data processing apparatus, cause the apparatus to perform the operations or actions.

The term “data processing apparatus” or “data processing system” refers to data processing hardware and encompasses various apparatus, devices, and machines for processing data, including programmable processors, computers, or combinations thereof. The data processing apparatus can include special purpose logic circuitry, such as a field programmable gate array (FPGA) or an application specific integrated circuit (ASIC). The data processing apparatus can include code that creates an execution environment for computer programs, such as code that constitutes processor firmware, a protocol stack, a database management system, an operating system, or combinations thereof.

The term “computer program” refers to a program, software, a software application, an app, a module, a software module, a script, or code. The computer program can be written in any form of programming language, including compiled, interpreted, declarative, or procedural languages, or combinations thereof. The computer program can be deployed in any form, including as a standalone program or as a module, component, subroutine, or other unit suitable for use in a computing environment. The computer program can correspond to a file in a file system and can be stored in a portion of a file that holds other programs or data, such as one or more scripts stored in a markup language document, in a single file dedicated to the program in question, or in multiple coordinated files, such as files that store one or more modules, sub programs, or portions of code. The computer program can be executed on one computer or on multiple computers that are located at one site or distributed across multiple sites and interconnected by a data communication network.

The term “database” refers to any collection of data. The data can be unstructured or structured in any manner. The data can be stored on one or more storage devices in one or more locations. For example, an index database can include multiple collections of data, each of which may be organized and accessed differently.

The term “engine” refers to a software-based system, subsystem, or process that is programmed to perform one or more specific functions. The engine can be implemented as one or more software modules or components or can be installed on one or more computers in one or more locations. A particular engine can have one or more computers dedicated thereto, or multiple engines can be installed and running on the same computer or computers.

The processes and logic flows described herein can be performed by one or more computers executing one or more computer programs to perform functions by operating on input data and generating output data. The processes and logic flows can also be performed by special purpose logic circuitry, or by a combination of special purpose logic circuitry and one or more computers.

A computer or special purpose logic circuitry executing the one or more computer programs can include a central processing unit, including general or special purpose microprocessors, for performing or executing instructions and one or more memory devices for storing the instructions and data. The central processing unit can receive instructions and data from the one or more memory devices, such as read only memory, random access memory, or combinations thereof, and can perform or execute the instructions. The computer or special purpose logic circuitry can also include, or be operatively coupled to, one or more storage devices for storing data, such as magnetic, magneto optical disks, or optical disks, for receiving data from or transferring data to. The computer or special purpose logic circuitry can be embedded in another device, such as a mobile phone, a personal digital assistant (PDA), a mobile audio or video player, a game console, a Global Positioning System (GPS), or a portable storage device, e.g., a universal serial bus (USB) flash drive, as examples.

Computer readable media suitable for storing the one or more computer programs can include any form of volatile or non-volatile memory, media, or memory devices. Examples include semiconductor memory devices, e.g., EPROM, EEPROM, or flash memory devices, magnetic disks, e.g., internal hard disks or removable disks, magneto optical disks, CD-ROM disks, DVD-ROM disks, or combinations thereof.

Aspects of the disclosure can be implemented in a computing system that includes a back end component, e.g., as a data server, a middleware component, e.g., an application server, or a front end component, e.g., a client computer having a graphical user interface, a web browser, or an app, or any combination thereof. The components of the system can be interconnected by any form or medium of digital data communication, such as a communication network. Examples of communication networks include a local area network (LAN) and a wide area network (WAN), e.g., the Internet.

The computing system can include clients and servers. A client and server can be remote from each other and interact through a communication network. The relationship of client and server arises by virtue of the computer programs running on the respective computers and having a client-server relationship to each other. For example, a server can transmit data, e.g., an HTML page, to a client device, e.g., for purposes of displaying data to and receiving user input from a user interacting with the client device. Data generated at the client device, e.g., a result of the user interaction, can be received at the server from the client device.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A method for attributing searches with digital content comprising:
receiving, by the one or more processors, a search performed on a user device;
identifying, by the one or more processors, at least one of a brand, product, or service from the search;
mapping, by the one or more processors, the identified brand, product, or service to at least one of a brand, product, or service identified in digital content;
determining, by the one or more processors, that the search was performed within a threshold time range from the digital content being viewed based on the mapping; and
attributing, by the one or more processors, the search to the digital content based on the search being performed within the threshold time range from the digital content being viewed.

2. The method of claim 1, further comprising:
receiving, by the one or more processors, the digital content viewed on the user device; and
identifying, by the one or more processors, the brand, product, or service identified in the digital content.

3. The method of claim 1, wherein the search comprises at least one of a text search, image search, video search, application search, artificial intelligence interface, or artificial intelligence agent.

4. The method of claim 1, wherein identifying the brand, product, or service from the search comprises using a machine learning model to perform at least one of natural language processing or image or video analysis.

5. The method of claim 4, wherein identifying the brand, product, or service comprises extracting search terms from the search.

6. The method of claim 5, wherein extracting the search terms comprises using a machine learning model to perform natural language processing.

7. The method of claim 1, wherein mapping the identified brand, product, or service from the search to the brand, product, or service identified in the digital content is based on a knowledge graph.

8. The method of claim 7, wherein the knowledge graph indicates a similarity of brands, products, or services identified in the search and the digital content.

9. The method of claim 1, wherein identifying the brand, product, or service from the search further comprises storing the identified brand, product, or service with a timestamp indicating when the search was performed on the user device.

10. The method of claim 1, further comprising storing the brand, product, or service identified in the digital content with a timestamp indicating when the digital content was viewed on the user device.

11. The method of claim 1, wherein determining that the search was performed within the threshold time range further comprises comparing a timestamp indicating when the digital content was viewed with a timestamp indicating when the search was performed.

12. The method of claim 11, wherein determining that the search was performed within the threshold time range further comprises determining that the timestamp indicating when the digital content was viewed was within the threshold time range from the timestamp indicating when the search was performed.

13. The method of claim 1, further comprising maintaining, by the one or more processors, a count of attributions for the search to the digital content.

14. The method of claim 13, further comprising generating, by the one or more processors, a histogram comprising the count of attributions.

15. The method of claim 13, further comprising identifying, by the one or more processors, categories of the brand, product, or service from the digital content.

16. The method of claim 15, further comprising determining, by the one or more processors, a mind share count based on the count of attributions and the categories of the brand, product, or service.

17. The method of claim 16, wherein determining the mind share count further comprises determining a fraction of the count of attributions out of a total number of searches for the category of the brand, product, or service.

18. A system comprising:
one or more processors; and
one or more storage devices coupled to the one or more processors and storing instructions that, when executed by the one or more processors, cause the one or more processors to perform the method of claim 1.

19. A non-transitory computer readable medium for storing instructions that, when executed by one or more processors, cause the one or more processors to perform the method of claim 1.
